(19) United States
(12) Patent Application Publication
(10) Pub. No.: US 2010/0312866 A1
(43) Pub. Date: Dec. 9, 2010

(54) REDUNDANCY PAIR DETECTING METHOD, COMMUNICATION DEVICE AND RECORDING MEDIUM FOR RECORDING REDUNDANCY PAIR DETECTION PROGRAM

(75) Inventor: Kazuhiro MIYASHITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/793,116

(22) Filed: Jun. 3, 2010

(30) Foreign Application Priority Data
Jun. 4, 2009 (JP) 2009-135140

(51) Int. Cl. G06F 15/16; G06F 15/177

(52) U.S. Cl. 709/221; 709/224; 709/245

(57) ABSTRACT

A communication device to detect combinations of redundantizable network adapters from among a plurality of network adapters includes an acquiring unit for acquiring respective MAC addresses, a transmitting unit for setting a first network adapter included in the plurality of network adapters as a transmit source and the respective network adapters as transmit destinations and transmitting a probe packet from the transmit source to the transmit destinations at the layer 2 level using the MAC addresses, an extracting unit for extracting an second network adapter, that is, the network adapter which has received the probe packet from among the network adapters other than the first network adapter, and a detecting unit for detecting the first network adapter and the second network adapter as combinations of the redundantizable network adapters.

### CROSS-REFERENCE TO RELATED APPLICATIONS

This application is based upon and claims the benefit of priority of the prior Japanese Patent Application No. 2009-135140, filed on Jun. 4, 2009, the entire contents of which are incorporated herein by reference.

### FIELD

Various embodiments described herein relate to a redundancy pair detecting method of detecting a pair of network adapters which are redundantizable (which may be probably combined to have a redundancy configuration), a communication device, and a recording medium for recording a redundancy pair detection program.

### BACKGROUND

In a business system in an enterprise, a network to which servers are connected is redundantized (configured to have redundancy) in order to ensure the reliability in communication. For redundantization of the network concerned, network adapters such as NICs (Network Interface Cards) included in the server and network switches such as HUBs are also redundantized. For example, in the case that a failure has occurred in one of NICs which are duplexed (combined to have a duplex configuration), the server uses another NIC. As a result, it may become possible for the server to continue communication.

Incidentally, in a communication unit misconnection relieving system in a duplexed device, there is proposed a communication unit misconnection relieving system of the type which is used in a duplexed device in which in the case that misconnection of a cable has occurred in a duplex configuration in which devices and interfaces are duplexed, setting of connection is automatically switched to reconnect the cable (see, for example, Japanese Unexamined Patent Application Publication No. 2006-279404).

In addition, in a multiplexed network connection device system, there is proposed a multiplexed network connection device system of the type in which a duplexed network connection device is utilized to improve the performance by distributing the load to respective devices in normal operation and when a failure has occurred, its availability is maintained with no intervention of software of a host computer (see, for example, Japanese Unexamined Patent Application Publication No. 2000-244526).

For example, in the case that the NICs are to be duplexed, an operator finds a combination of duplexible NICs and performs setting to duplex the NICs. However, in the case that the NICs which have been duplexed are NICs whose duplexing is originally impossible, the NICs which have been erroneously duplexed may cause a failure in communication.

### SUMMARY

A communication device, which is connected to a network to detect combinations of redundantizable network adapters from among a plurality of network adapters, includes an acquiring unit for acquiring respective MAC addresses of the plurality of network adapters, a transmitting unit for setting a first network adapter included in the plurality of network adapters as a transmit source and the respective network adapters other than the first network adapter included in the plurality of network adapters as transmit destinations and transmitting a probe packet from the transmit source to the transmit destinations at the layer 2 level using the MAC addresses which have been acquired as the addresses of the first network adapter and the network adapters other than the first network adapter, an extracting unit for extracting an second network adapter, that is, the network adapter which has received the probe packet from among the network adapters other than the first network adapter, and a detecting unit for detecting the first network adapter and the second network adapter as combinations of the redundantizable network adapters.

The object and advantages of the embodiments will be realized and attained by means of the elements and combinations particularly pointed out in the claims.

It is to be understood that both the foregoing general description and the following detailed description are exemplary and explanatory and are not restrictive of the embodiments, as claimed.

### BRIEF DESCRIPTION OF DRAWINGS

FIG. 1 is a diagram illustrating a configuration of an NIC pair detection system;

FIG. 2 is a diagram illustrating an example of a configuration of a server;

FIG. 3 is a diagram illustrating an example of an NIC pair detection unit;

FIG. 4A is a diagram illustrating an example of a pair array (an array of paired NICs);

FIG. 4B is a diagram illustrating an example of a pair array;

FIG. 4C is a diagram illustrating an example of a pair array;

FIG. 5A is a diagram illustrating an example of a probe packet;

FIG. 5B is a diagram illustrating an example of a script;

FIG. 5C is a diagram illustrating an example of a script;

FIG. 5D is a diagram illustrating an example of a script;

FIG. 6A is a diagram illustrating an example of a configuration of NICs and switches;

FIG. 6B is a diagram illustrating an example of a configuration of NICs and switches;

FIG. 6C is a diagram illustrating an example of a configuration of NICs and switches;

FIG. 7 is a diagram illustrating a flow of a process of generating a master NIC array; and

FIG. 8 is a diagram illustrating a flow of a pair detecting process.

### DESCRIPTION OF EMBODIMENTS

According to the study that the inventors hereof have made, for example, in the case that an operator intends to execute setting to duplex NICs, it may be necessary for the operator to detect duplexible NICs from among a plurality of NICs that a server includes. The duplexible NICs are ones all the types, the communication protocols and the communication speeds of which match each other. However, it may not be easy for the operator to detect the duplexible NICs from among many NICs while visually inspecting the specification of each NIC. Therefore, an error may occur in detection to cause a failure in communication.

Thus, it may be thought to repeat packet transmission/reception and analysis between a server (a self server) which includes the NICs and another server (a server of a communication mate) in order to detect the duplexible NICs. Owing to the above mentioned operations, it may become possible to confirm a connection state between the self sever and the mate server so as to detect the duplexible NICs on the side of the self server on the basis of a result of confirmation.

However, a method of detecting the duplexible NICs on the basis of the communication with the mate server as mentioned above is applied to communication performed at a level higher than the layer 3 level and hence setting of the IP address of the mate server may be indispensable. Therefore, it may be necessary for the operator to get and set in advance the IP addresses of both the self server and the mate server. Use of the IP addresses may induce such a problem that after a network has been configured to be duplexed, a user will be forced to use the IP addresses or will be forced to change the IP addresses, which may be a great burden on the user.

An NIC pair detecting method which will be described hereinbelow is designed to make it possible to detect combinations of duplexible NICs with no burden on the user.

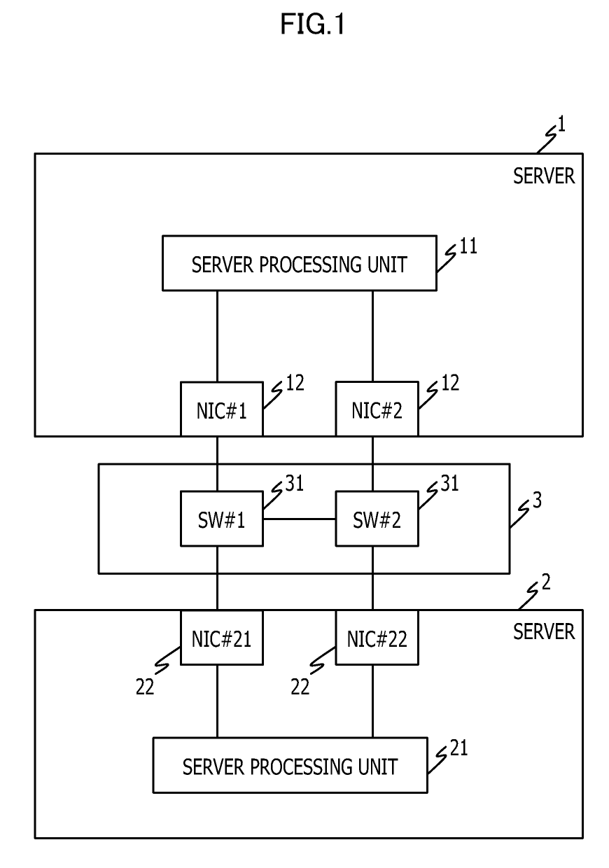

FIG. 1 is a diagram illustrating a configuration of a computer network system.

The computer network system includes a server 1, a server 2 and a network 3. The servers 1 and 2 are communication devices or computers which communicate with each other. Therefore, for example, the server 2 is a communication mate with which the server 1 communicates. The network 3 connects the server 1 with the server 2.

The network 3 includes a plurality of network switches (SWs) 31. The SWs 31 are part of the network 3. In the computer network system illustrated in FIG. 1, the plurality of SWs 31 are connected with one another so as to be communicable with one another at the layer 2 level which will be described later.

The server 1 includes a server processing unit 11 and a plurality of NICs (Network Interface Cards) 12. The server processing unit 11 executes various processes that the server 1 has to execute. In other words, the server processing unit 11 executes various processes to implement various functions other than the NICs 12 that the server 1 includes. The NICs 12 are network adapters that the server 1 includes. As the NIC used in this system, any NIC may be used as long as it supports Ethernet (a registered trademark).

The server processing unit 11 is connected to the plurality of NICs 12. The NICs 12 correspond to the SWs 31. That is, the respective NICs are connected to their corresponding SWs 31. The server processing unit 11 transmits a packet to another server and receives a packet therefrom via the NIC 12 and the SW 31.

In the computer network system illustrated in FIG. 1, the network 3 is configured to be duplexed by using two SWs 31. Thus, the server 1 includes two NICs 12 and the server 2 also includes two NICs 12 accordingly. Owing to the above mentioned arrangement, the servers 1 and 2 are duplexed and connected with each other. In the following, duplexing will be described as an example of redundantization.

In the following, in the case that the plurality of NICs 12 are to be discriminated from one another, the respective NICs 12 will be designated by NIC#1, NIC#2 and the like. The same thing also applies to NICs 22 and the SWs 31.

The server 2 has a configuration which is the same as that, for example, of the server 1. Although, in the following, detection of combinations of duplexible NICs 12 in the server 1 will be described, the same thing also applies to the server 2.

The server 2 is a communication mate of the server 1. However, in detection of combinations of duplexible NICs 12 in the server 1, the server 1 will not communicate with the server 2 as described later. Thus, the server 1 detects combinations of duplexible NICs 12 by taking only the presence of the SWs 31 into consideration, leaving the presence of the server 2 out of consideration. Therefore, in the example illustrated in FIG. 1, the network 3 that connects the server 1 with the server 2 is represented by the SWs 31 connected to the server 1.

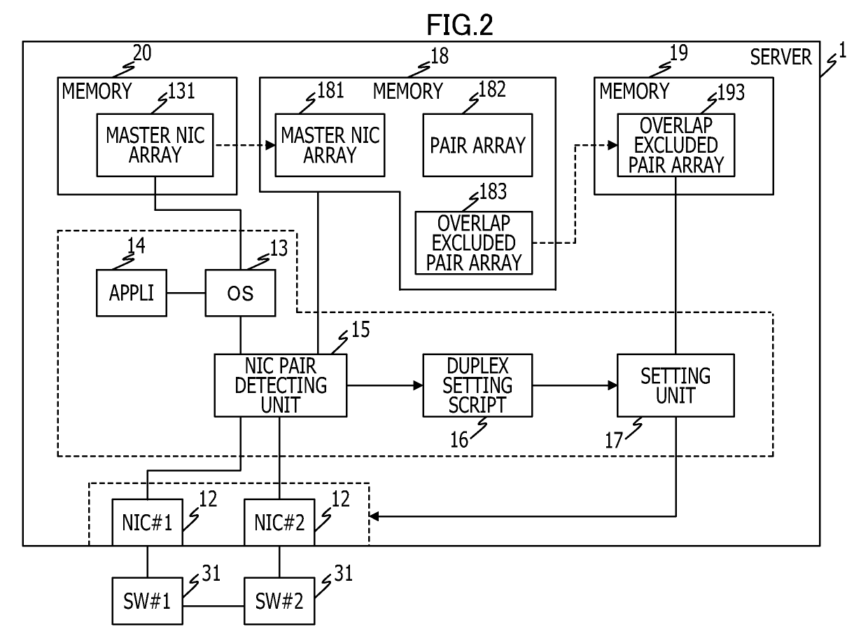

FIG. 2 is a diagram illustrating an example of a configuration of a server in the computer network system illustrated in FIG. 1.

The server 1 includes an OS (Operating System) 13, an appli (application) 14, an NIC pair detecting unit 15, a duplex setting script 18, a setting unit 17, a memory 18, a memory 19 and a memory 20. In other words, these elements constitute the server processing unit 11 in FIG. 1. The OS 13, the application 14, the NIC pair detecting unit 15, the duplex setting script 16 and the setting unit 17 are executed using a processor not illustrated in the drawing. The memory 18 is a storage area that the NIC pair detecting unit 15 uses. The memory 19 is a storage area that the setting unit 17 uses. The memory 20 is a storage area that the OS 13 uses.

The OS 13 manages and controls hardware resources and software resources that the server 1 includes and processes tasks of the server 1. The OS 13 includes a master NIC array 131 which has been prepared in advance in a memory or a storage area that the OS 13 uses. The master NIC array 131 will be described later.

The application (abbreviated as the appli in FIG. 2) 14 is an application program that a user uses. The application 14 is used to communicate with an application in the server 2 via the OS 13, the NIC 12 and the network 3 after the operation of the computer network system or the server 1 has been started.

The NIC pair detecting unit 15 detects pairs of duplexible NICs from among the plurality of NICs 12 that the server 1 includes. The duplexible NICs 12 are NICs all the types, the communication protocols, the communication speeds and others of which match each other. The above mentioned detecting process is executed as a pre-process before the operation of the computer network system is started or the server 1 is introduced into the computer network system concerned.

The NIC pair detecting unit 15 acquires an overlap excluded pair array 183 in the memory 18 as a result of execution of the detecting process. The overlap excluded pair array 183 stores pairs of duplexible NICs 12 which have been detected. The overlap excluded pair array 183 may be of a format other than the array format, such as, for example, a table format or a list format. The same thing also applies to a master NIC array 181 and a pair array 182 which will be described later. The NIC pair detecting unit 15 prepares the master NIC array 181 and the pair array 182 in the memory 18 in the course of acquisition of the overlap excluded pair array 183. The master NIC array 181, the pair array 182 and the overlap excluded pair array 183 will be described later.

Incidentally, the term “pair” of the NICs 12 may include a combination of, for example, three NICs 12, in reality, in addition to the combination of two NICs 12. Therefore, the NIC pair detecting unit 15 may detect a “combination” or “set” of redundantized NICs 12 from among the NICs 12 included in the server 1.

At the completion of execution of the detecting process, the NIC pair detecting unit 15 calls (or starts (the same thing also applies to the same parts)) the duplex setting script 16 and notifies the called duplex setting script 16 of combinations of duplexible NICs 12. The duplex setting script 16 is a program in which a simple process is described or a processing unit for executing a process concerned. In other words, the duplex setting script 16 executes setting to duplex (thus, redundantize) a plurality of NICs 12. The duplex setting script 16 is, for example, a shell script. As an alternative, the NIC pair detecting unit 15 may notify the duplex setting script 16 of the overlap excluded pair array 183 or the location thereof.

The duplex setting script 16 which has been called from the NIC pair detecting unit 15 receives a predetermined parameter from the NIC pair detecting unit 15. Then, the duplex setting script 16 executes a process which has been set in advance on the basis of the received parameter. That is, in the case that the received parameter correctly corresponds to the setting unit 17, the duplex setting script 16 calls the setting unit 17. On the other hand, in the case that the received parameter does not correctly correspond to the setting unit 17, the duplex setting script 16 does not call the setting unit 17 and sends the OS 13 an error notification.

The duplex setting script 16 calls (or starts (the same thing also applies to the same parts)) the setting unit 17 and notifies the called setting unit 17 of the combinations of duplexible NICs 12. The setting unit 17 is a program for setting to duplex the NICs 12 or a processing unit for executing a process concerned. In other words, the setting unit 17 executes setting to duplex (thus, redundantize) the plurality of NICs 12. As an alternative, the duplex setting script 16 may notify the setting unit 17 of the overlap excluded pair array 183 or the location thereof.

The setting unit 17 which has been called from the duplex setting script 16 receives a predetermined parameter from the duplex setting script 16. The setting unit 17 copies the overlap excluded pair array 183 in the memory 18 and stores the copied array into the memory 19 on the basis of the received parameter to prepare an overlap excluded pair array 193. The setting unit 17 executes setting to duplex the NICs 12 on the basis of the overlap excluded pair array 193. Incidentally, the setting unit 17 notifies the OS 13 of, for example, the NICs 12 which have been duplexed so as to be used in communication with the server 2 after the operation of the server 1 has been started.

As described above, the duplex setting script 16 which serves as a first setting unit merely sends the parameter to the setting unit 17 which serves as a second setting unit in reality and does not execute setting to duplex the NICs 12. Owing to the provision of the duplex setting script 16 between the NIC pair detecting unit 15 and the setting unit 17, it is sufficient for the NIC pair detecting unit 15 to send the duplex setting script 16 the parameter and the NIC pair detecting unit 15 need not take the configuration of the setting unit 17 into consideration.

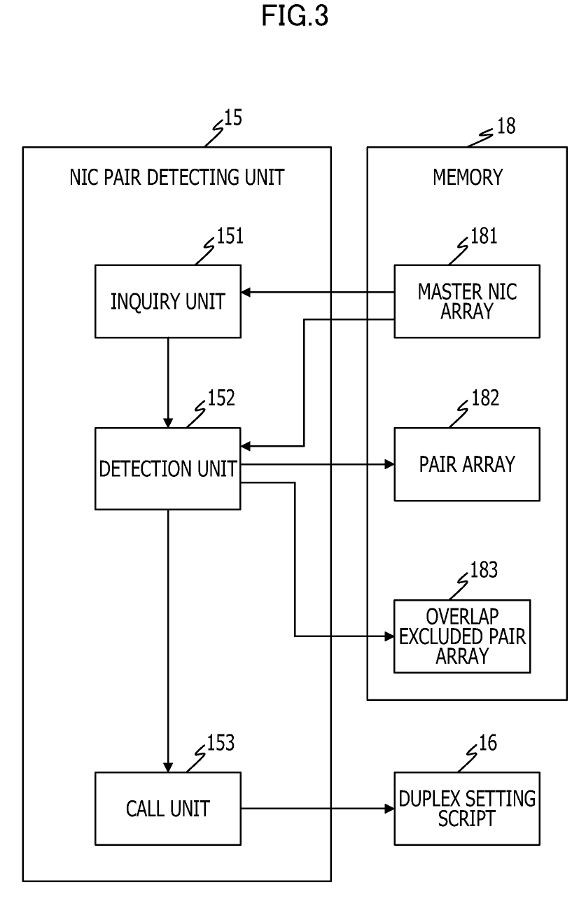

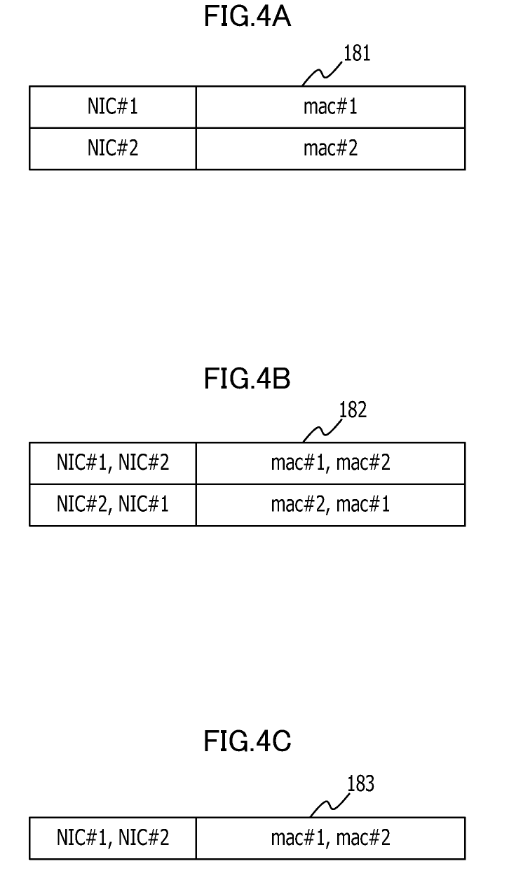

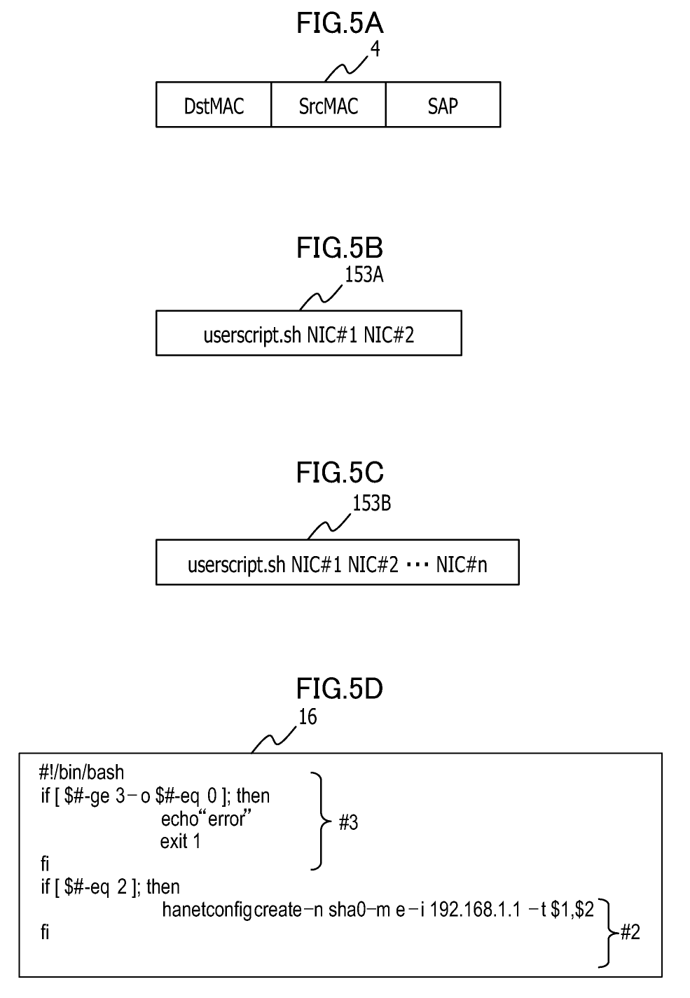

FIG. 3 is a diagram illustrating an example of the NIC pair detecting unit in the server illustrated in FIG. 2, FIGS. 4A to 4C are diagrams illustrating examples of pair arrays. FIG. 5A is a diagram illustrating an example of a probe packet and FIGS. 5B to 5D are diagrams illustrating examples of scripts.

The NIC pair detecting unit 15 includes an inquiry unit 151, a detection unit 152 and a call unit 153. When an operator who executes setting to duplex the NICs 12 in the server 1 turns on the power source of the server 1, the server 1 is boot-called, the OS 13 is called and then a log-in message is displayed on a monitor screen (not illustrated in the drawing). Then the operator logs in the server 1 to call the NIC pair detecting unit 15 via the OS 13.

In the NIC pair detecting unit 15 which has been called via the OS 13, the inquiry unit 151 is an acquiring unit for acquiring respective MAC addresses of the plurality of NICs 12 from the OS 13. For example, the inquiry unit 151 copies the master NIC array 131 and stores the copied array into the memory 18 via the OS 13 to prepare the master NIC array 181. The MAC addresses of the NICs 12 are stored in the master NIC array 131. Each of the MAC addresses of the NICs 12 so stored is used as a transmit object to which a probe packet 4 which will be described later is transmitted and a receive object from which the probe packet 4 is received. The inquiry unit 151 notifies the detection unit 152 of completion of preparation of the master NIC array 181.

Incidentally, each of the NICs 12 includes the MAC address (Media Access Control address) as a physical address which is uniquely determined. For example, an ID (identification number) of the inherent 48-bit length is allocated to each NIC 12 as the MAC address. Therefore, the MAC addresses of the NICs NIC#1, NIC#2 and the like are uniquely determined.

On the other hand, the SW 31 is a communication procedure (a communication protocol) on the layer 2 (the data link layer) and is a network switch used to transfer the packet 4. The SW 31 is, for example, a bridge. The layer 2 is situated on the second layer of an OSI (Open Systems Interconnection) reference model and is a layer which has determined a communication procedure to transfer the packet between appliances which are directly coupled to (physically connected with) each other over the network 3. The layer 2 is an upper hierarchy of the layer 1 (the physical layer) which is the first layer of the OSI reference model and defines physical connection and a lower hierarchy of the layer 3 (the network layer) for routing a communication path on the network 3. Incidentally, the layer 3 is a layer of a communication procedure used to transfer the packet 4 between communication appliances having IP address routing tables such as, for example, routers.

In addition, as illustrated in FIG. 1, the SWs SW#1 and SW#2 are respectively connected to the NICs NIC#1 and NIC#2 of the server 1 so as to communicate with the NICs 12 in accordance with a communication procedure at the layer 2 level. The SWs SW#1 and SW#2 are connected to communicate with each other in the same manner as the above.

Therefore, a communication device which may require a communication procedure at a level higher than the layer 3 level such as a router is not installed between the NIC NIC#1 and the SW SW#1. On the other hand, a communication device which may require a communication procedure at the layer 2 level may be installed between the NIC NIC#1 and the SW SW#1. The SWs SW#1 and SW#2 may be connected to communicate with each other in the same manner as the above.

FIG. 4A illustrates an example of the master NIC array 181. As described above, the master NIC array 181 is obtained by copying the master NIC array 131 and hence description of the master NIC array 181 will be omitted.

The master NIC array 181 stores the MAC address for each NIC name of each NIC 12. For example, “NIC#1” is the NIC name of the NIC NIC#1. The MAC address is a physical address which is uniquely determined for each NIC 12. For example, “mac#1” is the MAC address. The MAC address is an identification number of the inherent 48-bit length constituted of, for example, a hexadecimal number of 12 digits. Therefore, the master NIC array 181 indicates that the MAC address of the NIC name “NIC#1” is “mac#1”.

The detection unit 152 which has received the notification that preparation of the master NIC array 181 has been completed from the inquiry section 151 selects one NIC 12 with reference to the master NIC array 181. The detection unit 152 determines one NIC 12 so selected as an NIC 12 (a first NIC 12) used to transmit the probe packet 4. The detection unit 152 transmits the probe packet 4 from the first NIC 12 to another NIC 12. Another NIC 12 is each of the NICs 12 other than the first NIC 12 in the NICs 12 stored in the master NIC array 181. The detection unit 152 executes the above mentioned processing on all the NICs 12 included in the server 1, that is, the NICs 12 stored in the master NIC array 181.

In other words, the detection unit 152 sets the first NIC 12 included in the plurality of the NICs 12 as a transmit source and each of the NICs 12 included in the plurality of NICs other than the first NIC 12 as a transmit destination and transmits the probe packet 4 from the transmit source to the transmit destination. In packet transmission, the MAC addresses stored in the master NIC array 181 are used as the respective addresses of the first NIC 12 and the NICs 12 other than the first NIC 12.

FIG. 5A is a diagram illustrating an example of the probe packet 4.

The probe packet 4 is a test packet which is used to detect duplexible NICs 12. The probe packet 4 includes DstMAC, SrcMAC and SAP. DstMAC is the MAC address of another NIC 12 which is the transmit destination. SrcMAC is the MAC address of the first NIC 12 which is the transmit source. SAP is the identification number of the protocol used in communication concerned. The identification number of the protocol is uniquely determined.

The probe packet 4 is prepared using the detection unit 152. That is, the detection unit 152 stores the address of each of the NICs 12 other than the first NIC 12 which is stored in the master NIC array 181 into the probe packet 4 as Dst MAC. Therefore, the probe packets 4 of the number corresponding to that of the NICs 12 other than the first NIC 12 are prepared and transmitted. In addition, the detection unit 152 stores the address of the first NIC 12 stored in the master NIC array 181 into the probe packet 4 as SrcMAC. Further, the detection unit 152 stores the identification number of the protocol that the first NIC 12 uses into the probe packet 4 as SAP.

As described above, the MAC addresses are used in packet transmission and reception and hence the probe packet 4 is transmitted and received at the layer 2 level. In addition, the SWs 31 are connected to communicate with the NICs 12 at the layer 2 level as described above. Therefore, in the case that there exists the NIC 12 (the second NIC 12) all the type, transmission protocol, transmission speed and others of which match those of the first NIC 12 in the NICs 12 other than the first NIC 12, the second NIC 12 is allowed to receive the probe packet from the first NIC 12. The NICs 12 other than the second NIC 12 are not allowed to receive the probe packet 4 from the first NIC 12. For the reasons as mentioned above, in the case that the second NIC 12 has received the probe packet 4 from the first NIC 12, the first NIC 12 and the second NIC 12 may be detected as a combination of duplexible NICs.

Incidentally, the detection unit 152 requests the NIC 12 to transmit the probe packet 4. The NIC 12 which has been requested to transmit the probe packet 4 transmits the probe packet 4 to the NIC 12 concerned. The NIC 12 which has received the probe packet 4 transmits the received probe packet 4 to the detection unit 152. Owing to the above mentioned operations, it may become possible for the detection unit 152 to know whether there exists the NIC 12 which has received the probe packet 4.

Next, the detection unit 152 judges whether there exists the NIC 12 which has received the transmitted probe packet 4 in the NICs 12 other than the first NIC 12. In the case that there exists the NIC 12 which has received the probe packet 4, the detection unit 152 extracts the second NIC 12 corresponding to the NIC 12 which has received the probe packet 4 from among the NICs 12 other than the first NIC 12. As the second NIC 12, one or a plurality of NICs 12 is(are) extracted. The detection unit 152 detects the first NIC 12 and one second NIC 12 so extracted as the combination of duplexible NICs 12. The combination of duplexible NICs 12 is obtained in the form of the pair array 182.

That is, in the case that there exists the NIC 12 which has received the transmitted probe packet 4, the detection unit 152 prepares the pair array 182. Specifically, the detection unit 152 stores the NIC name and the MAC address of the first NIC 12 and the NIC name and the MAC address of the NIC 12 which has received the probe packet 4 into the pair array 182.

FIG. 4B illustrates an example of the pair array 182.

In the pair array 182, the MAC addresses corresponding to the respective NIC names are stored for each combination (pair) of the NIC name of the first NIC 12 with the NIC name of the second NIC 12. For example, in the combination of the NIC names of “NIC#1, NIC#2”, the first is the NIC name of the first NIC 12 and the second is the NIC name of the second NIC 12. In the combination of the MAC addresses “mac#1, mac#2”, the first is the MAC address of the first NIC 12 and the second is the MAC address of the second NIC 12.

Therefore, the first line of the pair array 182 indicates that, for example, the first NIC 12 (the transmit source) having the NIC name represented by NIC#1 and the MAC address represented by mac#1 may be probably combined with the second NIC 12 (the transmit destination) having the NIC name represented by NIC#2 and the MAC address represented by mac#2 to have a duplex configuration. The second line of the pair array 182 indicates that, for example, the first NIC 12 (the transmit source) having the NIC name represented by NIC#2 and the MAC address represented by mac#2 may be probably combined with the second NIC 12 (the transmit destination) having the NIC name represented by NIC#1 and the MAC address represented by mac#1 to have a duplex configuration. That is, in the pair array 182, some combinations of duplexible NICs 12 are stored in an overlapping state.

Thus, the detection unit 152 extracts combinations (hereinafter, referred to as overlapping combinations) in which the first NIC 12 and the second NIC 12 in one combination overlap the first NIC 12 and the second NIC 12 in another combination from among the extracted combinations of duplexible NICs 12, leaves one of the overlapping combinations and discards other combinations.

Specifically, the detection unit 152 prepares the overlap excluded pair array 183 in which the overlapping combinations are excluded from the air array 182. That is, in the case that combinations of NICs 12 stored in the pair array 182 do not overlap one another, that is, are not the overlapping combinations, the detection unit 152 stores the combinations of NICs 12 into the overlap excluded pair array 183. In the case that combinations of NICs 12 stored in the pair array 182 overlap one another, that is, are the overlapping combinations, the detection unit stores only one of the overlapping combinations into the overlap excluded pair array 183. When preparation of the overlap excluded pair array 183 has been completed, the detection unit 152 sends the call unit 153 a notification that preparation of the overlap excluded pair array 183 has been completed.

FIG. 4C illustrates an example of the overlap excluded pair array 183.

The overlap excluded pair array 183 is a table in which the overlapping combinations are excluded from the combinations stored in the pair array 182. In the overlap excluded pair array 183, the MAC addresses corresponding to the respective NIC names are stored for each combination (pair) of the NIC name of the first NIC 12 with the NIC name of the second NIC 12 as in the case in the pair array 182.

On the other hand, as apparent from comparison with the pair array 182 illustrated in FIG. 4B, in the overlap excluded pair array 183, the overlapping combination in the pair array 182 is excluded. That is, the second line of the pair array 182 in FIG. 4B is discarded and only the first line is stored into the overlap excluded pair array 183. As a result, the overlap excluded pair array 183 indicates that the NIC 12 having the NIC name represented by NIC#1 and the MAC address represented by mac#1 may be probably combined with the NIC 12 having the NIC name represented by NIC#2 and the MAC address represented by mac#2 to have a duplex configuration and either one of the NICs 12 may be the transmit source or the transmit destination.

The call unit 153 which has received the notification that preparation of the overlap excluded pair array 183 has been completed from the detection unit 152 reads data which has been predetermined out of the overlap excluded pair array 183. The call unit 153 calls the duplex setting script 16 by executing a script call format 153A using the read data. The script call format 153A is part of the call unit 153 and is executed to call the duplex setting script 16 in reality.

FIG. 5B is a diagram illustrating an example of the script call format 153A. The scrip call format 153A is executed to call the duplex setting script 16 used to duplex the NICs 12.

The call unit 153 finds that, for example, the combination of the NICs NIC#1 and NIC#2 is the combination of duplexible NICs 12, that is, the combination of the NICs 12 to be duplexed with reference to the overlap excluded pair array 183. Then, the call unit 153 generates the script call format 153A on the basis of the above finding. In the script call format 153A, “userscript. sh” is a function name used to call the duplex setting script 16. “NIC#1, NIC#2” is an argument indicative of the combination of duplexible NICs 12. When the call unit 153 executes the script call format 153A, the duplex setting script 16 is called and the argument “NIC#1, NIC#2” indicative of the combination of duplexible NICs 12 is transferred to the called duplex setting script 16.

FIG. 5C is a diagram illustrating an example of a script call format 153B. The script call format 153B is executed to call an n-plex setting script (n is an integer of 3 or more) for n-plexing the NICs 12 unlike the script call format 153A.

In the script call format 153B, “userscript. sh” is a function name used to call the n-plex setting script. “NIC#1, NIC#2 . . . NIC#n” is an argument indicative of a combination of n-plexible NICs 12 (which may be probably n-plexed). When the call unit 153 executes the script call format 153B, the n-plex setting script is called and the argument “NIC#1, NIC#2 . . . NIC#n” indicative of the combination of n-plexible NICs 12 is transferred to the called n-plexed setting script.

As apparent from comparison with the example illustrated in FIG. 5B, the function name in the script call format 153A is the same as that in the script call format 153B. Thus, although the duplex setting script 16 and the n-plex setting script are called by using the same call function in reality, these scripts are different from each other in terms of the argument which can be processed.

The duplex setting script 16 which has been called from the call unit 153 calls the setting unit 17 using the argument which has been transferred from the call unit 153.

FIG. 5D illustrates an example of the duplex setting script 16. The duplex setting script 16 illustrated in FIG. 5D is the duplex setting script 16 of the type which is called by executing the script call format 153A illustrated in FIG. 5B.

For example, it is supposed that the setting unit 17 which is called executes the process of duplexing the NICs 12 and does not execute a process of tripling (that is, n-plexing) the NICs 12. In other words, it is assumed that the setting unit 17 is a duplex setting unit. In the above mentioned situation, only the duplex setting script 16 is prepared and any n-plex setting script is not prepared.

On the other hand, in some cases, a combination of NICs 12 which may be probably tripled is detected in addition to the combination of duplexible NICs 12.

In the above mentioned case, with respect to the combination of duplexible NICs 12, the duplex setting script 16 is called by executing the script call format 153A illustrated in FIG. 5B and two arguments are transferred thereto. On the other hand, with respect to the combination of NICs which may be probably tripled, the duplex setting script 16 is called with the same function as that in the script call format 153B in FIG. 5C and three arguments are transferred thereto.

However, the duplex setting script 16 and the setting unit 17 do not triple the NICs 12. Thus, even though three arguments are transferred thereto, processing of these arguments may be impossible, that is, tripling of the NICs 12 may be impossible. Therefore, a process of outputting an error from the duplex setting script 16 may be necessary.

Thus, the duplex setting script 16 includes a part #3 used to execute error processing. Incidentally, a part 2# is a part used to execute a process of calling the setting unit 17 that executes duplexing of NICs 12. A command “hanetconfig” is an example of a command used to call the setting unit 17.

As described above, in the computer network system illustrated in FIG. 1, detection of the combination of duplexible NICs 12 is possible. Thus, the operator need not retrieve the connection status of the NICs 12. Therefore, the personnel expenses involved, for example, when a large number of servers are introduced may be reduced. Since the duplex setting script 16 is called from the call unit 153 and the setting unit 17 is called from the duplex setting script 16, detection of the combination of duplexible NICs 12 which may be possibly duplexed and duplexing of these NICs 12 may be automatically executed, thereby eliminating the possibility that the operator makes a mistake in the procedure when the NICs 12 are to be duplexed.

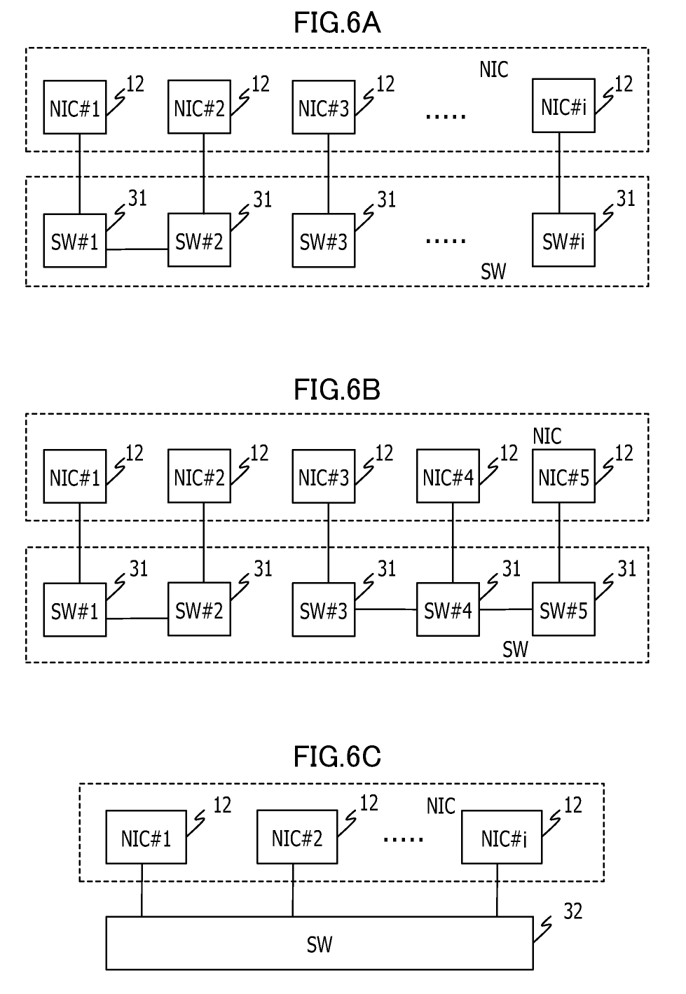

FIGS. 6A to 6C are diagrams illustrating examples of redundantization of the NICs 12.

In the example illustrated in FIG. 6A, only the NICs NIC#1 and NIC#2 are duplexed and other NICs NIC#3 to NIC #i are not duplexed in the plurality of NICs NIC#1 to NIC#i included in the server 1. This fact synonymously means that only the switches SW#1 and SW#2 corresponding to the NICs NIC#1 and NIC#2 are connected with each other at the layer 2 level and other switches SW#3 to SW#i are not connected with one another at the layer 2 level. In the example illustrated in FIG. 6A, the NICs NIC#1 and NIC#2 are processed by executing the script call format 153A illustrated in FIG. 5B.

In the example illustrated in FIG. 6B, the NICs NIC#1 and NIC#2 are duplexed and the NICs NIC#3 to NIC#5 are tripled in the plurality of NICs NIC#1 to NIC#5 included in the server 1 This fact synonymously means that the switches SW#1 and SW#2 corresponding to the NICs NIC#1 and NIC#2 are connected with each other at the layer 2 level and the switches SW#3 to SW#5 corresponding to the NICs NIC#3 to NIC#5 are connected with one another at the layer 2 level. The switches SW#2 and SW#3 are not connected with each other at the layer 2 level.

The NICs NIC#1 and NIC#2 are processed by executing the script call format 153A illustrated in FIG. 5B and the NICs NIC#3 to NIC#5 are processed by executing the script call format 153B illustrated in FIG. 5C. Therefore, in the above mentioned case, for example, the duplex setting script 16 and the setting unit 17 for duplexing the NICs 12 and a triple setting script and a setting unit for tripling the NICs 12 are installed.

In the example illustrated in FIG. 6C, the plurality of NICs NIC#1 to NIC#i included in the server 1 are i-plexed. This fact synonymously means that one SW 32 is installed corresponding to the NICs NIC#1 to NIC #i. Within the SW 32, connection ports corresponding to the NICs NIC#1 to NIC#i are connected with one another all at the layer 2 level. This fact synonymously means that the single SW 32 serves as the switches SW#1 to SW#i which correspond to the NICs NIC#1 to NIC#i and are connected with these NICs all at the layer 2 level. In the above mentioned case, the duplex setting script 16 and the setting unit 17 for duplexing the NICs 12 or a triple setting script and a setting unit for tripling the NICs 12 are installed.

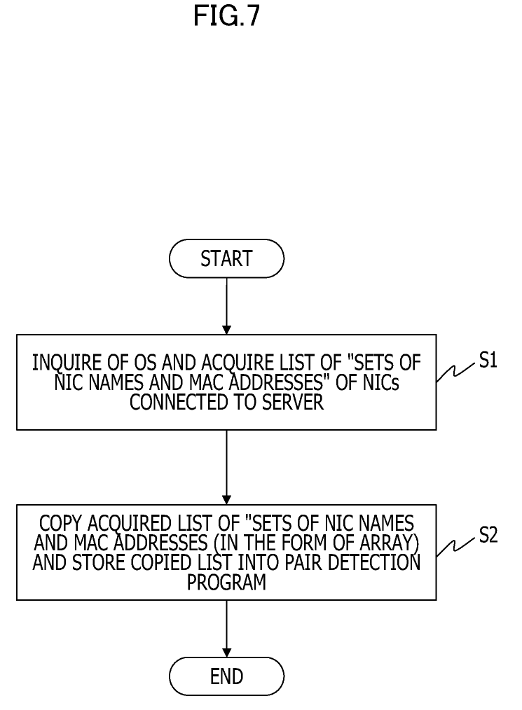

FIG. 7 illustrates an example of a flow of a master NIC array generating process.

When the OS 13 starts the NIC pair detecting unit 15, the inquiry unit 151 of the NIC pair detecting unit 15 inquires of the OS 13 about a list of “sets of NIC names and MAC addresses” (that is, the master NIC array 131) and acquires the master NIC array from the OS 13 (step S1).

The inquiry unit 151 stores the acquired master NIC array 131 into the memory 18 (step S2). As a result, the master NIC array 181 is prepared in the memory 18. Then, the inquiry unit 151 notifies the detection unit 153 of the NIC pair detecting unit 15 of preparation of, for example, the master NIC array 181.

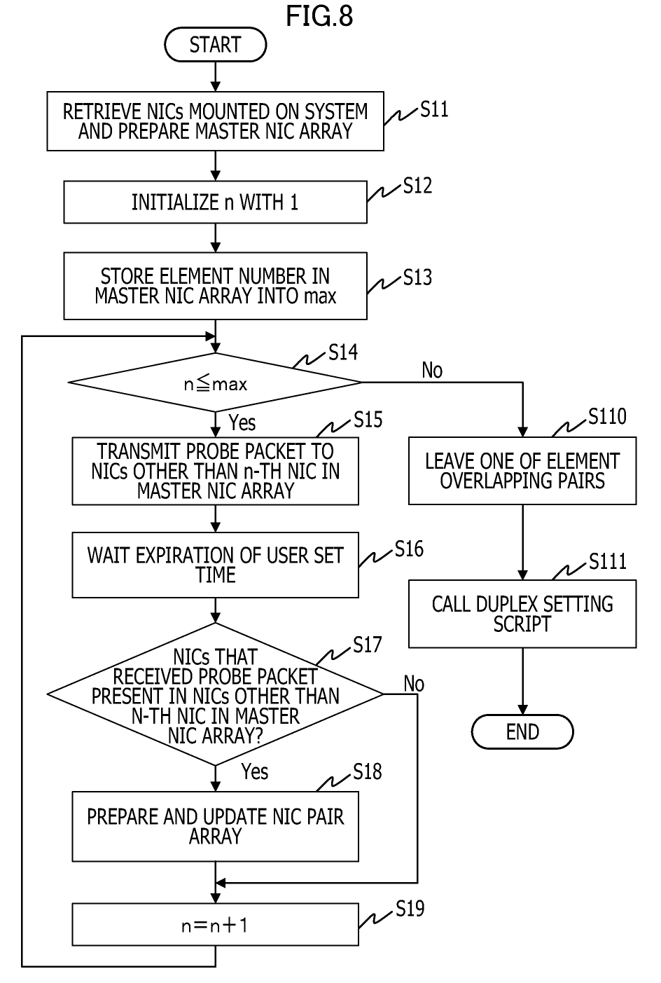

FIG. 8 is a diagram illustrating a flow of a pair detecting process.

As described above with reference to FIG. 7, the inquiry unit 151 prepares the master NIC array 181 and sends the detection unit 152 of the NIC pair detecting unit 15 a notification that the master NIC array 181 has been prepared (step S11).

The detection unit 152 which has received the notification sets “1” to the redundantized NIC number (the number of NICs 12 which are redundantized) “n” which is a first variable (step S12). As a result, the redundantized NIC number “n” is initialized. Then, the detection unit 152 sets “the element number of the master NIC array 181” to a second variable “max” (step S13). Incidentally, the element number is the number of NICs 12 stored in the master NIC array 181.

Then, the detection unit 152 judges whether the redundantized NIC number “n” is not more than “max” (step S14). In the case that the redundantized NIC number “n” is not more than “max” (Yes, at step S14), the detection unit 152 transmits the probe packet 4 to the NICs 12 other than the n-th NIC 12 in the master NIC array via the SWs 31 (step S15) and waits until a time which has been set by a user has expired (step S16).

After the time which has been set by the user has expired, the detection unit 152 judges whether there exist the NICs 12 other than the n-th NIC 12 which have been allowed to receive the probe packet 4 which has been transmitted at step S15 in the master NIC array 181 (step S17).

In the case that it has been judged that there exist the NICs 12 which have received the probe packet 4 (step S17, Yes), the detection unit 152 prepares or updates the pair array 182 (step S18). On the other hand, in the case that it has been judged that there is no NIC 12 which has received the probe packet 4 (step S17, No), execution of the process at step S1 is omitted.

Next, the detection unit 152 adds +1 to the current redundantized NIC number “n” to obtain the new redundantized NIC number n=n+1 (step S19) and repeats the process at step S14.

At step S14, in the case that the redundantized NIC number “n” is larger than “max” (step S14, No), the detection unit 152 units pairs of NICs 12 in which the elements overlap one another to one pair of NICs 12 in the pair array 182 (step S110). As a result, the detection unit 152 prepares the overlap excluded pair array 183 on the basis of the pair array 182. Then, the detection unit 152 sends the call unit 153 of the NIC pair detecting unit 15 a notification, for example, that the overlap excluded pair array 183 has been prepared.

The call unit 153 which has received the notification calls the duplex setting script 16 (step S111). Then, the call unit 153 transmits the duplex setting script 16 so called the NIC names and the MAC addresses of the pair of NICs 12 stored in the overlap excluded pair array 183 to terminate execution of the process.

As described above, the duplex setting script 16 which has received the NIC names and the MAC addresses of the pair of NICs 12 from the NIC pair detecting unit 15 calls the setting unit 17 to redundantize the pair of NICs 12. Therefore, the procedures to detect the pair of NICs 12 to be redundantized and to redundantize the NICs 12 may be automatically executed.

In the system according to the above mentioned embodiment, the control program corresponding to each flowchart for implementing the functions of the system is implemented by executing the program using the processor. The program may be recorded into a tangible recording medium, such as a storage device (HDD, ROM, RAM, etc.) and a portable recording medium (CD-ROM, DVD).

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. The media described above may be non-transitory media.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. A redundancy pair detecting method of detecting a combination of redundantizable network adapters from among a plurality of network adapters included in a communication device that is connected to a network, the redundancy pair detecting method comprising:
acquiring respective MAC addresses of the plurality of network adapters;
setting a first network adapter included in the plurality of network adapters as a transmit source and the other network adapters as transmit destinations;
transmitting a probe packet from the transmit source to the transmit destinations at the layer 2 level using the MAC addresses that have been acquired as the addresses of the first network adapter and the other network adapters;
extracting a second network adapter, the second network adapter being a network adapter among the other network adapters that has received the probe packet; and
detecting the first network adapter and the second network adapter as combinations of the redundantizable network adapters.

2. The method according to claim 1, further comprising:
extracting combinations in which all the first network adapters and second network adapters overlap one another from among the combinations of redundantizable network adapters; and
retaining only one of the combinations in which all the first and second network adapters overlap one another and discarding other combinations.

3. The method according to claim 1, wherein
the network includes a plurality of network switches corresponding to the plurality of network adapters, and
the network switches corresponding to the first network adapter and the second network adapter that have been detected as the combination of the redundantizable network adapters are connected to be communicable with one another at the layer 2 level.

4. The method according to claim 1, further comprising:
calling a first setting unit for setting to redundantize the plurality of network adapters and notifying the called first setting unit of the combination of the redundantizable network adapters; and
calling a second setting unit for setting to redundantize the plurality of network adapters from the first setting unit and notifying the second setting unit of the combination of the redundantizable network adapters.

5. A communication device that is connected to a network to detect combinations of redundantizable network adapters from among a plurality of network adapters, the communication device comprising:
an acquiring unit configured to acquire respective MAC addresses of the plurality of network adapters;
a transmitting unit configured to set a first network adapter included in the plurality of network adapters as a transmit source and the other network adapters as transmit destinations and to transmit a probe packet from the transmit source to the transmit destinations at the layer 2 level using the MAC addresses that have been acquired as the addresses of the first network adapter and the other network adapters;
an extracting unit configured to extract an second network adapter, the second network adapter being a network adapter among the other network adapters that has received the probe packet; and
a detecting unit configured to detect the first network adapter and the second network adapter as combinations of the redundantizable network adapters.

6. A non-transitory computer readable recording medium recording a redundancy pair detection program used to detect combinations of redundantizable network adapters from among a plurality of network adapters installed in a communication device connected to a network, wherein the redundancy pair detection program makes a computer as the communication device execute:
acquiring respective MAC addresses of the plurality of network adapters;
setting a first network adapter included in the plurality of network adapters as a transmit source and the other network adapters as transmit destinations and transmitting a probe packet from the transmit source to the transmit destinations at the layer 2 level using the MAC addresses that have been acquired as the addresses of the first network adapter and the other network adapters;
extracting a second network adapter, the second network adapter being a network adapter among the other network adapters that has received the probe packet; and
detecting the first network adapter and the second network adapter as combinations of the redundantizable network adapters.
